(19) United States
(12) Patent Application Publication
(10) Pub. No.: US 2008/0023555 A1
(43) Pub. Date: Jan. 31, 2008

(54) Aperture stop in imaging reader

(76) Inventors: Edward Barkan, Miller Place, NY (US); Mark Drzymala, Commack, NY (US); David Tsi Shi, Stony Brook, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/496,306

(22) Filed: Jul. 31, 2006

(51) Int. Cl. G06K 7/10

(52) U.S. Cl. 235/462.41

(57) ABSTRACT

An aperture stop focuses light from indicia onto a solid-state imager of an imaging reader. The aperture stop has an open aperture with a scan dimension sized to resolve symbol elements, and with a height dimension to allow sufficient light to be captured. A cylindrical lens can be used to collect additional light. The aperture stop provides a large depth of focus and enables symbols to be read over a wide field of view. The need to use an expensive multiple lens assembly with the imager is eliminated.

### DESCRIPTION OF THE RELATED ART

Flat bed laser readers, also known as horizontal slot scanners, have been used to electro-optically read one-dimensional bar code symbols, particularly of the Universal Product Code (UPC) type, at a point-of-transaction workstation in supermarkets, warehouse clubs, department stores, and other kinds of retailers for many years. As exemplified by U.S. Pat. No. 5,059,779; U.S. Pat. No. 5,124,539 and U.S. Pat. No. 5,200,599, a single, horizontal window is set flush with, and built into, a horizontal countertop of the workstation. Products to be purchased bear an identifying symbol and are typically slid or swiped across the horizontal window through which a multitude of scan lines in a scan pattern is projected in a generally upward direction. Each scan line is generated by sweeping a laser beam from a laser. When at least one of the scan lines sweeps over a symbol associated with a product, the symbol is processed and read.

Instead of, or in addition to, a horizontal slot scanner, it is known to provide a vertical slot scanner, which is typically a portable reader placed on the countertop such that its window is generally vertical and faces an operator at the workstation. The generally vertical window is oriented perpendicularly to the horizontal window, or is slightly rearwardly inclined. A scan pattern generator within the vertical slot scanner also sweeps a laser beam and projects a multitude of scan lines in a scan pattern in a generally outward direction through the vertical window toward the operator. The operator slides or swipes the products past either window from right to left, or from left to right, in a “swipe” mode. Alternatively, the operator merely presents the symbol on the product to the center of either window in a “presentation” mode. The choice depends on operator preference or on the layout of the workstation.

These point-of-transaction workstations have been long used for processing transactions involving products associated with one-dimensional symbols each having a row of bars and spaces spaced apart along one direction, and for processing two-dimensional symbols, such as Code 39, as well. Code 39 introduced the concept of vertically stacking a plurality of rows of bar and space patterns in a single symbol. The structure of Code 39 is described in U.S. Pat. No. 4,794,239. Another two-dimensional code structure for increasing the amount of data that can be represented or stored on a given amount of surface area is known as PDF417 and is described in U.S. Pat. No. 5,304,786.

Both one- and two-dimensional symbols can also be read by employing solid-state imagers, instead of moving a laser beam across the symbols in a scan pattern. For example, an image sensor device may be employed which has a one- or two-dimensional array of cells or photosensors, which correspond to image elements or pixels in a field of view of the device. Such an image sensor device may include a one- or two-dimensional charge coupled device (CCD) or a complementary metal oxide semiconductor (CMOS) device and associated circuits for producing electronic signals corresponding to a one- or two-dimensional array of pixel information over a field of view.

It is therefore known to use a solid-state device for capturing a monochrome image of a symbol as, for example, disclosed in U.S. Pat. No. 5,703,349. It is also known to use a solid-state device with multiple buried channels for capturing a full color image of a target as, for example, disclosed in U.S. Pat. No. 4,613,895. It is common to provide a two-dimensional CCD with a 640×480 resolution commonly found in VGA monitors, although other resolution sizes are possible.

It is also known to focus light from the symbol onto the photosensors by an imaging lens assembly in front of the image sensor device. The lens assembly typically comprises a plurality of lenses of different sizes and powers. Although generally satisfactory for its intended purpose, the known imaging lens assembly requires its lenses to be positioned accurately with respect to the image sensor device to assure proper focusing onto the photosensors. If the lenses are not positioned accurately enough, the imager will not be able to read symbols over its entire specified working range. This is particularly true when a short focal length lens is used as in cases where a high magnification or a very wide field of view is needed. The shorter the focal length, the more accurately the imaging lenses must be positioned.

In some applications, the reader will be required to read a long symbol that is positioned very close to the imager. These applications include consumer appliances and low cost readers for point-of-transaction workstations in cramped retail environments. Sometimes, there is insufficient space available to move the reader away from the symbol. This requires that the imaging lens assembly creates a high quality image of the symbol on the image sensor device across a very wide angle. In other words, light rays that form the extreme ends of the image pass through a focusing lens of the imaging lens assembly at a large angle with respect to an optical axis of the focusing lens. Expensive multiple lenses and focusing adjustment are therefore needed to capture good quality images all the way out to the ends of the field of view. However, such multiple lens assemblies and focusing adjustment add cost to the reader

### SUMMARY OF THE INVENTION

One feature of the present invention resides, briefly stated, in a reader for, and a method of, electro-optically reading indicia, especially one-dimensional symbols. The symbol includes elements of different light reflectivity, i.e., bars and spaces. The elements have respective widths and are spaced along a scan direction lengthwise of the symbol. The elements have respective heights and extend along a height direction generally orthogonal to the scan direction. The reader could be embodied as a stationary or portable point-of-transaction workstation having a window, or as a handheld reader having a window. In some applications, the window can be omitted, in which event, the reader has a windowless opening at which the indicia are located for reading. As used herein, the term “presentation area” is intended to cover both a window and a windowless opening. In the case of the workstation, the symbol is swiped past, or presented to, the presentation area and, in the case of the handheld reader, the reader itself is moved and the presentation area is aimed at the symbol. In the preferred embodiments, the reader is installed in a retail establishment, such as a supermarket, especially in a cramped environment, or in a consumer appliance, such as a coffee maker, in one's home.

A one- or two-dimensional, solid-state imager is mounted in the reader, and includes an array of image sensors operative for capturing light from a one- or two-dimensional symbol or target through the presentation area during the reading. Preferably, the array is a CCD or a CMOS array.

When the reader is operated in low light or dark environments, an illuminator is also mounted in the reader and illuminates the symbol during the reading with illumination light directed from an illumination light source through the presentation area. The illumination light source is preferably at least one light emitting diode (LED), and preferably a plurality of LEDs.

In accordance with this invention, an aperture stop having an open aperture is provided in the housing. The open aperture is formed with a width or scan dimension along the scan direction for focusing the light from the indicia over a wide field of view onto the sensors. The width dimension is chosen to provide adequate resolution across the respective widths of the bars and spaces of the symbol to be read. No multiple lens assemblies are needed to achieve a wide field of view. Nor is any focusing adjustment performed, because the open aperture has a large depth of focus.

In the preferred embodiment, the open aperture has a height dimension that is elongated along the height direction generally orthogonal to the scan direction. If the array is a linear array extending along an array axis, then the height dimension is generally orthogonal to the array axis. The resulting aperture thus has a generally rectangular or ovoidal shape. This increased height serves to allow more light to pass through to the imager, as compared to a circular aperrture. The open aperture of this invention can be considered as a modified pin-hole that is used in a traditional two-dimensional picture-taking camera. A traditional, circular pin-hole would not be used for an imager for reading symbols, because the small traditional, circular pin-hole would reduce the quantity of light from the symbol that reaches the imager too much. Insufficient light degrades symbol reading and can cause reading failure. The greater height dimension is chosen to provide adequate light to pass through to the imager.

Additional light can be collected by placing a cylindrical lens close to the aperture, either upstream or downstream thereof, as considered along an optical path along which the light travels to the imager, and preferably the cylindrical lens is in contact with the aperture stop. A long lens axis of the cylindrical lens is positioned generally orthogonal to the height dimension of the open aperture. The cylindrical lens concentrates the light onto the imager, and does not alter the image-forming capability of the scan dimension of the aperture.

The aperture of this invention collects sufficient light to allow an imaging reader to function. The large depth of focus of the aperture does not require any focusing adjustment, even when used to image a wide field of view, or when a high magnification is used. The need to use an expensive multiple lens assembly is eliminated.

The amount of light reaching the imager decreases as the radial distance from the optical axis increases. In other words, the ends of the field of view will be darker than the center thereof. Signal processing circuitry or software could be used to deal with this change of signal level. However, the illuminator can be designed to emit illumination light that is brighter near the ends of the field of view than at the center thereof. For example, more LEDs can be provided at the ends, as compared to the center, of the field of view. Alternatively, the LEDs at the ends can be driven with stronger drive currents to allow them to emit brighter light.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a point-of-transaction workstation operative for capturing light from symbol-bearing targets in accordance with this invention;

FIG. 2 is a perspective view of an electro-optical reader operative in either a hand-held mode, or a workstation mode, for capturing light from symbol-bearing targets in accordance with this invention;

FIG. 3 is a block diagram of various components of the workstation of FIG. 1;

FIG. 4 is an exploded view of an optical assembly for focusing light onto an imager in accordance with this invention for use in the readers of FIGS. 1 or 2; and

FIG. 5 is an assembled view of the optical assembly of FIG. 4.

### DETAILED DESCRIPTION OF THE PREFERRED EMBODIMENTS

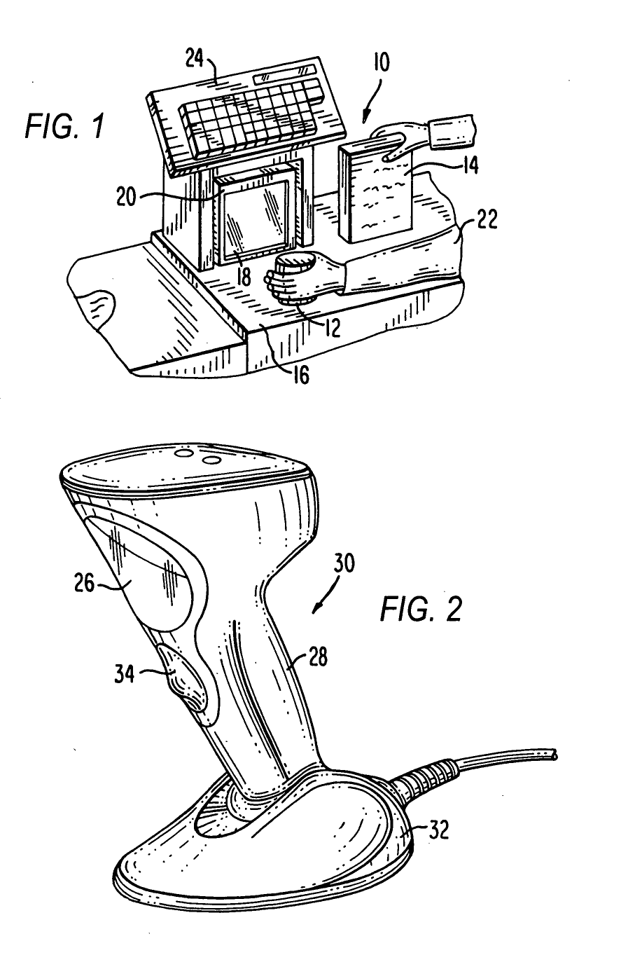

Reference numeral 10 in FIG. 1 generally identifies a workstation for processing transactions and specifically a checkout counter at a retail site at which products, such as a can 12 or a box 14, each bearing a target symbol, are processed for purchase. The counter includes a countertop 16 across which the products are slid at a swipe speed past a vertical window (i.e., presentation area) 18 of a box-shaped vertical slot reader 20 mounted on the countertop 16. A checkout clerk or operator 22 is located at one side of the countertop, and the reader 20 is located at the opposite side. A cash/credit register 24 is located within easy reach of the operator.

Reference numeral 30 in FIG. 2 generally identifies another reader having a different configuration from that of reader 20. Reader 30 also has a generally vertical window (i.e., presentation area) 26 and a gun-shaped housing 28 supported by a base 32 for supporting the reader 30 on a countertop. The reader 30 can thus be used as a stationary workstation in which products are slid or swiped past the vertical window 26, or can be picked up off the countertop and held in the operator's hand and used as a handheld reader in which a trigger 34 is manually depressed to initiate reading of the symbol.

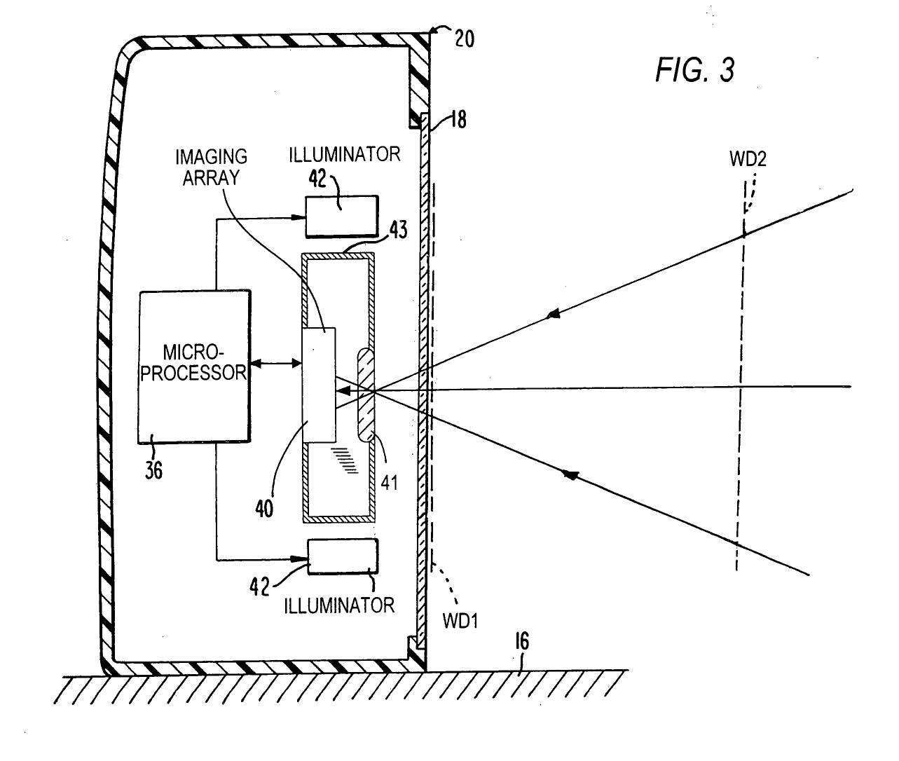

As schematically shown in FIG. 3, an imager 40 and an imaging lens assembly 41 are mounted in an enclosure 43 in either reader, such as the reader 20. The imager 40 is a solid-state device, for example, a CCD or a CMOS imager and has an array of addressable image sensors operative for capturing light through the window 18 from a target, for example, a one- or two-dimensional symbol, over a field of view and located in a working range of distances between a close-in working distance (WD1) and a far-out working distance (WD2). In a preferred embodiment, WD1 is about two inches from the imager array 40 and generally coincides with the window 18, and WD2 is about eight inches from the window 18. An illuminator is also mounted in the reader and preferably includes a plurality of light sources, e.g., light emitting diodes (LEDs) 42, arranged at opposite sides of the imager 40 to uniformly illuminate the target.

As shown in FIG. 3, the imager 40 and the illuminator LEDs 42 are operatively connected to a controller or microprocessor 36 operative for controlling the operation of these components. Preferably, the microprocessor is the same as the one used for decoding light scattered from the indicia and for processing the captured target images. In case the reader is incorporated in an appliance that is controlled by an appliance microprocessor, then the microprocessor 36 can be the same or different from the appliance microprocessor.

In operation, the microprocessor 36 sends a command signal to pulse the illuminator LEDs 42 for a short time period, say 500 microseconds or less, and energizes the imager 40 to collect light from a target symbol only during said time period. A typical array needs about 33 milliseconds to read the entire target image and operates at a frame rate of about 30 frames per second. The array may have on the order of one million addressable image sensors.

Although the aforementioned imaging lens assembly 41 is depicted as a single lens, this was done to simplify the drawing. In practice, the known lens assembly 41 includes a plurality of optical lenses arranged along the optical path to focus the illumination light from the indicia onto the imager. In the prior art, these lenses are configured with different sizes and different optical powers, thereby increasing the overall size of the assembly.

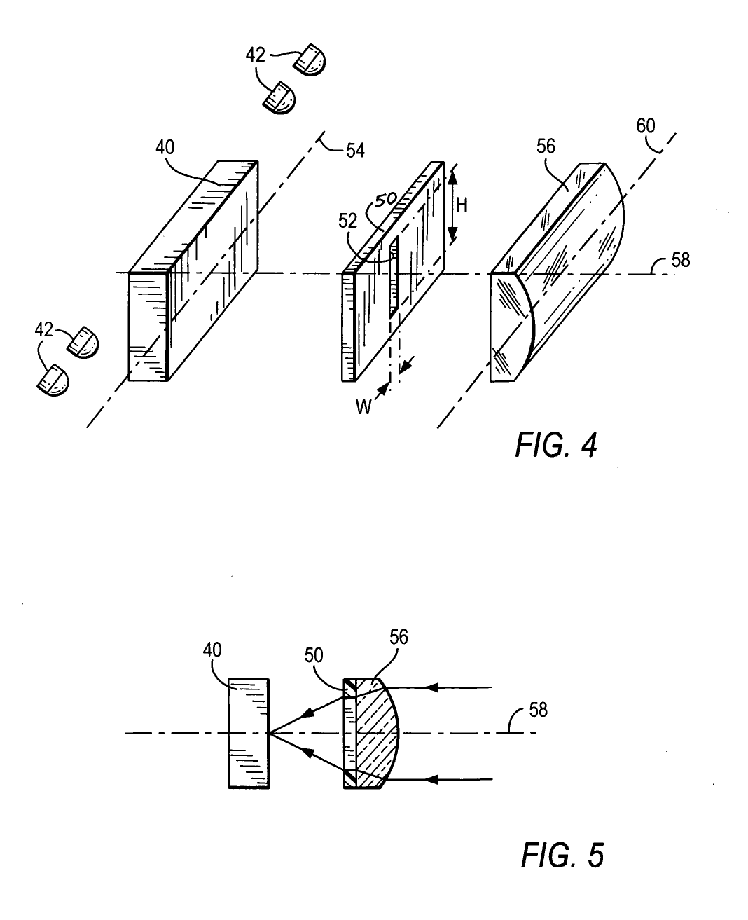

In accordance with the invention, as depicted in the exploded view of FIG. 4 and in the assembled view of FIG. 5, the lens assembly 41 has been eliminated and replaced by an aperture stop 50 having an open aperture 52 that is formed with a width or scan dimension W along a scan direction for focusing the light from the indicia over a wide field of view onto the sensors of the array 40. The width dimension is chosen to provide adequate resolution across the respective widths of the bars and spaces of the symbol to be read. No multiple lens assemblies are needed to achieve a wide field of view. Nor is any focusing adjustment performed, because the open aperture 52 has a large depth of focus.

In the preferred embodiment, the open aperture 52 has a height dimension H that is elongated along the height direction generally orthogonal to the scan direction. If the array 40 is a linear array extending along an array axis 54, then the height dimension is generally orthogonal to the array axis. The resulting aperture thus has a generally rectangular or ovoidal shape. This increased height serves to allow more light to pass through to the imager. The open aperture 52 of this invention can be considered as a modified pin-hole that is used in a traditional two-dimensional picture-taking camera. A traditional, circular pin-hole would not be used for an imager for reading symbols, because the small traditional, circular pin-hole would reduce the quantity of light from the symbol that reaches the imager too much. Insufficient light degrades symbol reading and can cause reading failure. The height dimension is chosen to provide adequate light to pass through to the imager.

Additional light can be collected by placing a cylindrical lens 56 close to the aperture 52, either upstream or downstream thereof, as considered along an optical path 58 along which the light travels to the imager 40, and preferably the cylindrical lens 56 is in contact with the aperture stop 50. A long lens axis 60 of the cylindrical lens 56 is positioned generally orthogonal to the height dimension of the open aperture and is parallel to the array axis 54. The cylindrical lens 56 concentrates the light onto the imager 40, and does not alter the image-forming capability of the scan dimension of the aperture.

The aperture 52 of this invention collects sufficient light to allow an imaging reader to function. The large depth of focus of the aperture does not require any focusing adjustment, even when used to image a wide field of view, or when a high magnification is used. The need to use an expensive multiple lens assembly is eliminated. Close-in symbols located at working distance WD1 can be read by the reader herein even over the wider field of view.

The amount of light reaching the imager 40 decreases as the radial distance from the optical axis 58 increases. In other words, the ends of the field of view will be darker than the center thereof. Signal processing circuitry or software could be used to deal with this change of signal level. However, the illuminator 42 can be designed to emit illumination light that is brighter near the ends of the field of view than at the center thereof. For example, more LEDs 42 can be provided at the ends, as compared to the center, of the field of view. Alternatively, the LEDs 42 at the ends can be driven with stronger drive currents to allow them to emit brighter light.

Each one-dimensional symbol includes elements of different light reflectivity, i.e., bars and spaces. The elements have respective widths and are spaced along a scan direction lengthwise of the symbol. Each width is an integral number of symbol modules. By way of numerical example, if the array has 1024 sensors or pixels along its length, and if the symbol is about 25 mm long, and if the size of each symbol module is about 12 mils, then there are about 12.5 pixels or sensors for each module. The elements have respective heights and extend along a height direction generally orthogonal to the scan direction.

As for the size of the width dimension W of the aperture, it is a function of the symbol module size, the symbol density, the contrast between the darker bars and the lighter spaces, and the maximum amount of light blur reflected from the symbol. In a system having a magnification of about three, the width dimension W of the aperture is about 5 mils.

It will be understood that each of the elements described above, or two or more together, also may find a useful application in other types of constructions differing from the types described above. Thus, readers having different configurations can be used.

While the invention has been illustrated and described as an aperture stop for focusing light, as well as a cylindrical lens for collecting additional light directed, onto an imager in an imaging reader, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. A reader for electro-optically reading indicia having elements of different light reflectivity spaced apart along a scan direction, comprising:
a) a housing having a presentation area;
b) a solid-state imager in the housing and including an array of image sensors for capturing light through the presentation area from the indicia during reading; and
c) an aperture stop having an open aperture formed with a scan dimension along the scan direction for focusing the light from the indicia onto the sensors over a wide field of view.

2. The reader of claim 1, wherein the open aperture is formed with a height dimension along a height direction generally orthogonal to the scan direction for collecting the light from the indicia.

3. The reader of claim 2, wherein the height dimension is greater than the scan dimension.

4. The reader of claim 1, wherein the open aperture has a generally rectangular shape.

5. The reader of claim 1, wherein the open aperture is elongated along a height direction generally orthogonal to the scan direction for collecting the light from the indicia, and wherein the image sensors are arranged along an array axis generally orthogonal to the height direction.

6. The reader of claim 1, and a cylindrical lens adjacent the aperture stop for collecting light from the indicia.

7. The reader of claim 1, wherein the open aperture is elongated along a height direction generally orthogonal to the scan direction for collecting the light from the indicia, and wherein the cylindrical lens extends along a lens axis that is generally orthogonal to the height direction.

8. The reader of claim 1, and an illuminator in the housing for illuminating the indicia during reading with illumination light directed from an illuminating light source through the presentation area, and wherein the aperture stop is operative for focusing the illumination light reflected and captured from the indicia onto the sensors.

9. The reader of claim 8, wherein the illuminating light source includes a plurality of light emitting diodes (LEDs).

10. The reader of claim 8, wherein the illuminator is operative for illuminating opposite ends of the field of view with the illumination light of higher intensity than a center of the field of view.

11. The reader of claim 1, wherein the housing has a handle for handheld operation.

12. The reader of claim 1, wherein the housing has a base for supporting the housing on a support surface for workstation operation.

13. A reader for electro-optically reading indicia having elements of different light reflectivity spaced apart along a scan direction, comprising:
a) housing means having a presentation area;
b) solid-state imager means in the housing and including an array of image sensors for capturing light through the presentation area from the indicia during reading; and
c) aperture stop means having an open aperture formed with a scan dimension along the scan direction for focusing the light from the indicia onto the sensors over a wide field of view.

14. A method of electro-optically reading indicia having elements of different light reflectivity spaced apart along a scan direction, comprising the steps of:
a) capturing light through a presentation area of a reader from the indicia during reading by an array of image sensors of a solid-state imager; and
b) focusing the light from the indicia over a wide field of view onto the sensors, by positioning an aperture stop having an open aperture formed with a scan dimension along the scan direction adjacent the imager.

15. The method of claim 14, and forming the open aperture with a height dimension along a height direction generally orthogonal to the scan direction for collecting the light from the indicia.

16. The method of claim 15, and configuring the height dimension to be greater than the scan dimension.

17. The method of claim 14, and configuring the open aperture with a generally rectangular shape.

18. The method of claim 14, and elongating the open aperture along a height direction generally orthogonal to the scan direction for collecting the light from the indicia, and arranging the image sensors along an array axis generally orthogonal to the height direction.

19. The method of claim 14, and positioning a cylindrical lens adjacent the aperture stop for collecting light from the indicia.

20. The method of claim 19, and elongating the open aperture along a height direction generally orthogonal to the scan direction for collecting the light from the indicia, and configuring the cylindrical lens to extend along a lens axis that is generally orthogonal to the height direction.

21. The method of claim 14, and illuminating the indicia during reading with illumination light directed from an illuminating light source through the presentation area, and wherein the focusing step is performed by focusing the illumination light reflected and captured from the indicia onto the sensors.

22. The method of claim 21, and forming the illuminating light source as a plurality of light emitting diodes (LEDs).

23. The method of claim 21, wherein the illuminating step is performed by illuminating opposite ends of the field of view with the illumination light of higher intensity than a center of the field of view.

24. The method of claim 14, and the step of holding the reader by a handle for handheld operation.

25. The method of claim 14, and the step of supporting the reader on a support surface for workstation operation.

26. An optical assembly for electro-optically reading indicia having elements of different light reflectivity spaced apart along a scan direction, comprising:
a) a solid-state imager including an array of image sensors for capturing light from the indicia during reading; and
b) an aperture stop having an open aperture formed with a scan dimension along the scan direction for focusing the light from the indicia onto the sensors over a wide field of view.
